(19) United States
(12) Patent Application Publication
(10) Pub. No.: US 2005/0259626 A1
(43) Pub. Date: Nov. 24, 2005

(54) Method of communication

(75) Inventors: Vijay Devarapalli, Sunnyvale, CA (US); Meghana Sahasrabudhe, San Jose, CA (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/986,970

(22) Filed: Nov. 15, 2004

Related U.S. Application Data
(60) Provisional application No. 60/572,779, filed on May 21, 2004.

(51) Int. Cl. H04Q 7/00

(52) U.S. Cl. 370/338

(57) ABSTRACT

A method of communication includes the step of providing an address for a mobile node. The method also includes assigning a lifetime to the provided address and storing the assigned lifetime.

### FIELD OF THE INVENTION

The present invention relates to a method of communication.

### BACKGROUND OF THE INVENTION

A communication system is a facility which enables communication between two or more entities such as user terminal equipment and/or network entities and other nodes associated with a communication system. The communication may comprise, for example, communication of voice, electronic mail (email), text messages, data, multimedia and so on.

The communication may be provided by a fixed line and/or wireless communication interface. A feature of wireless communication systems is that they provide mobility for the users thereof. An example of communication systems providing wireless communication are public land mobile networks (PLMN). An example of the fixed line system is a public switched telephone network (PSTN).

A communication system typically operates in accordance with a given standard or specification which sets out what the various elements of a system are permitted to do and how that should be achieved. For example, the standard or specification may define if the user, or more precisely user equipment, is provided with a circuit switched server or a packet switched server or both. Communication protocols and/or parameters which should be used for the connection also typically defined. For example, the manner in which communication should be implemented between the user equipment and the elements of the communication networks is typically based on a predefined communication protocol. In other words, a specific set of “rules” on which the communication can be based needs to be defined to enable the user equipment to communicate via the communication system.

So called third generation communication systems are being introduced. These so called third generation systems use code division multiple access techniques. One example of such a third generation communication system is the cdma2000 system.

Current cdma2000 networks support three modes of service, simple IP(internet protocol)v4, simple IPv6 and mobile IPv4. The next release of cdma2000 packet data network (see proposed standard TIA 835D) plans to have mobile IPv6 as a fourth mode of service for the mobile station. The requirements for IPv6 mobility in cdma2000 have required that the dynamic assignment of home address and home agent for a mobile station be possible.

In one proposal, the mobile node (or mobile station) can auto-configure the home address based on the home prefix which it gets from the home agent which is assigned to it. This address would need to be authorised for use by the mobile node. The home agent has a binding cache memory when the mobile node has active sessions. The life time of this binding cache entry can be smaller than the life time of the home address. Once the home agent has deleted the binding cache entry, it will not keep state for the assigned home address. This can lead to the problem of a malicious node claiming the home address of another node and the network will not have any means to prohibit that behavior.

It is an aim of embodiments of the present invention to address the above described problems.

### SUMMARY OF THE INVENTION

According to a one aspect of the present invention there is provided a method of communication comprising the step of providing an address for a mobile node, assigning a lifetime to the provided address and storing the assigned lifetime.

According to a second aspect of the present invention there is provided a communication system comprising means for providing an address for a mobile node, means for assigning a lifetime to the address and means for storing the assigned lifetime.

According to a third aspect of the present invention there is provided a communication system comprising a mobile node arranged to generate an address for said mobile node and an authorization server for assigning a lifetime to the address and for storing the assigned lifetime.

According to a fourth aspect of the present invention there is provided an authorization server for use in a communication system, said server being arranged to assign a lifetime to an address provided for a mobile node and to store the assigned lifetime.

According to a fifth aspect of the present invention there is provided a mobile node for use in a communications network, said mobile node being arranged to generate a dynamic address and arranged to receive and store information relating to a lifetime of said address.

According to a sixth aspect of the present invention there is provided a method of authorizing a static address of a mobile node comprising the steps of sending the static address to an authorization server from a mobile node and authorizing said address at said authorization server.

### BRIEF DESCRIPTION OF DRAWINGS

For a better understanding of the present invention and as to how the same may be carried into effect, reference will now be made by way of example to the accompanying drawings in which:

FIG. 1 shows a network in which embodiments of the present invention can be implemented;

FIG. 2 shows the signal flow for dynamic assignment of the home address, in one embodiment of the present invention; and

FIG. 3 shows a message for providing home address lifetime information;

### DETAILED DESCRIPTION OF PREFERRED EMBODIMENTS OF THE PRESENT INVENTION

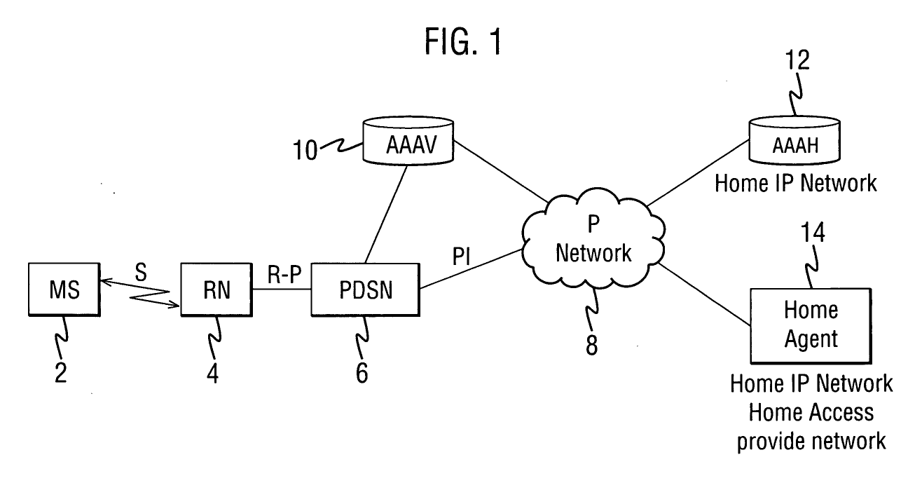

Reference is first made to FIG. 1 which shows a network in which embodiments of the present invention can be incorporated. This network is, by way of example a cdma2000 packet data network. It should be appreciated that embodiments of the present invention may be applied to any other network conforming to any other suitable standard. Other standards could for example include other third generation standards but are not limited thereto.

User equipment (also referred to in this document as a mobile node) is provided which may be a mobile station. The user equipment can take any suitable format. For example, the user equipment may be a portable computer, mobile telephone, personal data assistant, organiser or the like.

In this embodiment the user equipment is a mobile station 2 arranged to communicate with a radio network RN4 via a wireless connection 5. The radio network 4 may comprise, for example, base stations and base station control functions. The radio network 4 is connected to a packet data serving node (PDSN) 6. The PDSN 6 provides the network access gateway functionality. The PDSN is arranged to communicate with an IP network 8. The PDSN permits communication from the mobile station and to the mobile station to be routed via the IP network 8.

The PDSN 6 is also connected to an authentication, authorisation and accounting server 10. In the example shown in FIG. 1, the mobile station is not in its home network. Accordingly, the AAA entity 10, to which the PDSN 6 is connected, will be that of the visited network. This entity will be referred to as the AAAV 10. The AAAV 10 is also able to communicate with the IP network 8.

The IP network 8 is connected to the authentication, authorisation and accounting server 12 in the user's home IP network. This is the AAAH 12.

The IP network 8 is also connected to the home IP network 14 of the mobile station.

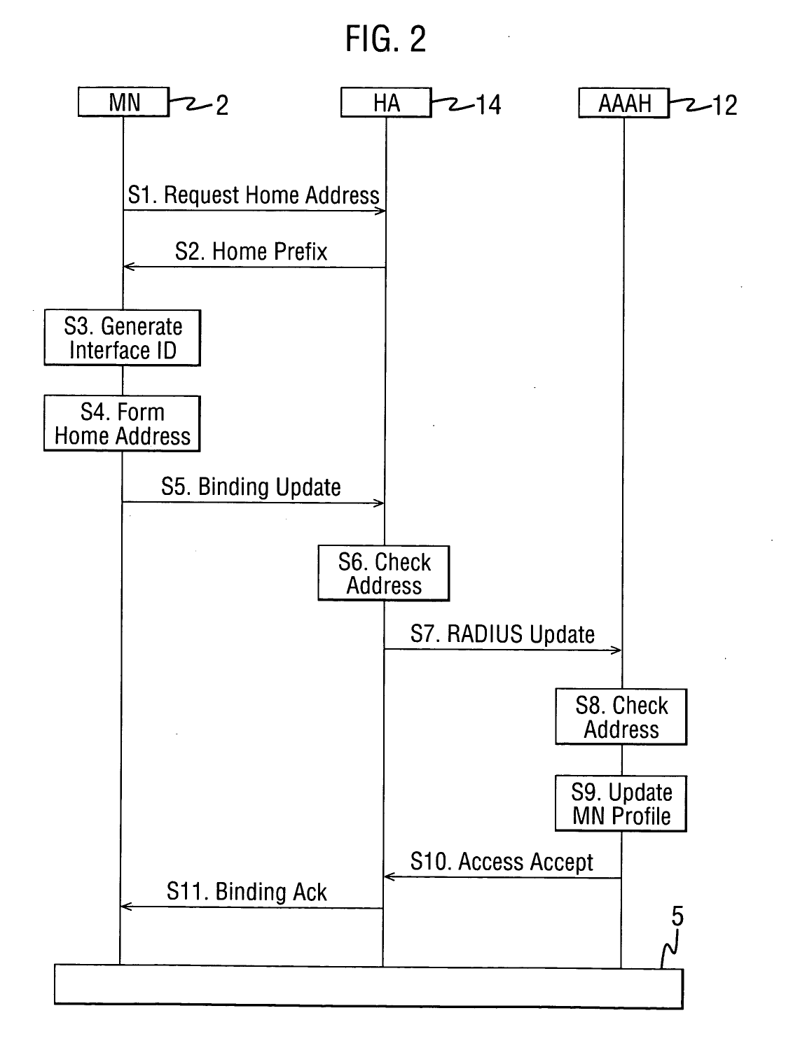

Reference will now be made to FIG. 2 which shows the signalling flow in a first embodiment of the present invention.

Shown in FIG. 2 are the mobile node or mobile station 2, the home agent 14 and the AAAH 12.

Before describing the signal flow in detail, the process will be summarised. In embodiments of the present invention, the home AAA can for example store the persistent state for the life time of the home address and the profile of the mobile node. In CDMA networks, the AAA infrastructure is utilised for authorising the use of this address by the mobile node.

A mobile node which connects to a PDSN 6 and wants to access a CDMA packet data network may desire to have a mobile IPv6 service offered by the network. If the mobile node 2 does not have a static home address, then in step S1, the mobile node requests a home address from the home agent 14.

If home agent assignment is also being requested, the home AAA server selects a home agent based on appropriate criteria. Once the home agent has been selected, this information will be conveyed to the mobile node.

In step S2, the home agent 14 provides the home prefix served by the home agent. It should be appreciated that in some embodiments of the present invention, once the mobile node 2 has identity information for the home agent, this will include the home prefix. Accordingly, steps S1 and S2 may be modified, omitted, or form part of the messaging for obtaining the identity of the associated home agent.

In step S3, the mobile node generates an interface ID. An interface ID is the last 64 bits of a 128 bit IPv6 Address. The 64 bit Home Prefix is concatenated with the 64 bit Interface ID to form the 128 bit Home Address. In particular, the mobile node is arranged to auto-configure the home address. It should be appreciated that there are a number of different methods which can be used for generating the interface ID. One method for generating randomized interface identifiers is for example specified in Privacy Extensions for Stateless Address Auto-configuration in IPv6. This is a RFC3041 IETF (Internet Engineering Task Force) proposal.

In step S4, the mobile node forms a home address by appending the generated interface identifier to the home prefix.

In step S5, the mobile node sends a Binding Update message to the home agent using the newly generated home address.

In step S6, the home agent first performs DAD Duplicate Address Detection. It is specified in RFC 1971, an IETF document. It checks to see if another mobile node associated with that same home agent is using the same home address by checking its binding cache. This home agent will not find a match if there are no other active sessions ongoing that utilise the generated home address.

In step S7, assuming that there is no match found, the home agent 14 sends a RADIUS access request message to the home AAA server which includes the home address being requested by the mobile node.

In step S8, the AAAH searches through the profiles of all the other mobile nodes to see if any other mobile node has that home address assigned to it with an unexpired life time. If no other mobile node has that home address assigned, the AAAH will up date the profile of the mobile node with that home address in step S9. The AAAH will also assign a lifetime for that home address. The lifetime which is assigned will depend on the implementation. For example, an operator may want the lifetime to be 2 days, another might like 2 months.

The assigned lifetime will also be stored in the profile of the mobile node.

In step S10, the AAAH 12 sends an access accept message to the home agent 14 including the lifetime that it has assigned for the home address to be used by the mobile node.

In step S11, the home agent sends a successful binding acknowledgement on receipt of the access accept message. This Binding Acknowledgement will include the lifetime of the home address in a new mobility option. This advises the mobile node about the lifetime for which its assigned home address will be valid. Accordingly, the mobile node will know that once this lifetime has expired, the mobile node will need to request another dynamically assigned address. Furthermore, since the AAAH updates the mobile nodes profile with the assigned lifetime, no other mobile node will be able to get that home address until this lifetime expires. This is regardless of whether or not the binding cache entry in the home agent has been deleted or not.

In one modification to the invention, step S8 may be modified. The lifetime may be assigned to the home agent by the AAAH or HA. If the home agent selects the lifetime, there will have to be another round of message exchange between the home agent and AAAH. In the first round the HA will only query the AAAH if a certain home address is in its persistent state. If yes, the lifetime associated with the home address is also queried

If the home address is not found in the persistent state, at this point there are two possibilities.
1) The AAAH chooses a lifetime, creates persistent state for that home agent, and sends back the lifetime in its reply to the home agent.
2) The AAAH replies saying no persistent state for this home address. Then the home address chooses a lifetime and sends another message to AAAH to create a persistent state for that home address and sends the lifetime with it.

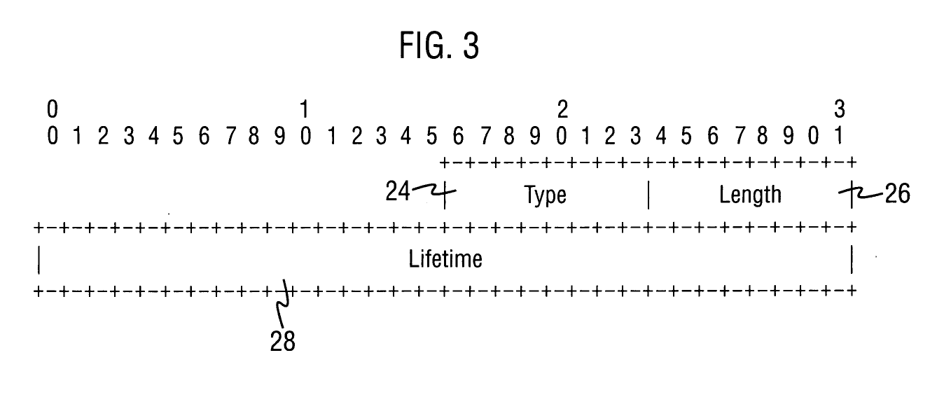

Reference will now be made to FIG. 3 which shows the form of part of the information which is included in the binding acknowledgement message sent in step S11. The message shown in FIG. 3 has three fields. As mentioned, the message shown in FIG. 3 may form part of a larger message. The first field 24 is an eight bit field indicating the type of message. In other words, it would indicate that the message is providing lifetime information. In the second field 26, which is also an eight bit field, this will indicate the length of the information. The third field 28 is 32 bit field which contains the lifetime information assigned to the dynamic address. The successful Binding Acknowledgement is sent only if the Mobile's generated home address was authorized by the network. So if the Mobile receives a successful BA it already knows the address since it autoconfigured it in the first place. If the binding acknowledgement comes back with a negative response (Home Address was not acceptable), then the Mobile generates another Home Address. The mobile node will use the same Home Prefix, generate a new Interface ID and form a new home address. It then sends this new Home Address in a new Binding Update message.

It should be appreciated that the sizes of these fields are given by way of example and in other implementations of the invention may of course differ.

Embodiments of the present invention can also be used with static addresses, that is addresses assigned to mobile nodes which do not change. If a static address is used, the following steps would be carried out. The first step would be step S5 and the Binding Update would include the static address. The AAAH already has the static address stored along with all the home addresses that have been assigned and the static home addresses of other mobile nodes. There is no need to update the profile. The AAAH will authorize the static address. The lifetime of a static address is assumed to be infinite and the AAAH does not need to send any assigned lifetime in the Binding acknowledgment message.

Embodiments of the present invention have the advantage that a mobile node cannot auto-configure and start using the home address of another mobile node. The profile of every mobile node which is stored at the home AAA server will have information on the home address that is assigned to it and the associated lifetime, even if the mobile node is currently off and does not have a binding cache entry at the home agent. This stops malicious mobile nodes from getting authorisation of a home address that is stolen from another mobile node.

In preferred embodiments of the present invention, the lifetime of the dynamically assigned home address is stored in the AAA server. It should be appreciated that in alternative embodiments of the present invention, the home address lifetime can be assigned by any other suitable entity, for example the home agent. The home address lifetime can be stored by any other suitable entity, for example, the home agent.

The AAAH prevents any other MN from claiming the home address for a certain duration irrespective of whether the MN is shut off, switched on but in dormant mode, or switched on with an active session. It also does not matter if the Home Agent has a binding cache or not. Additionally the MN can switch to a new home agent. The AAAH can authorize the address for the MN for that duration to any Home Agent.

Embodiments of the present invention may be used in for example an operator wireless local area network (OWLAN).

Embodiments of the present invention have used RADIUS. This is because cdma2000 specification have currently defined only RADIUS for authentication. Of course, any other protocol can be used. For example, DIAMETER may alternatively be used.

Embodiments of the invention can be applied in any other suitable network and not just cdma2000. The other networks may be third generation or otherwise.

1. A method of communication, the method comprising the steps of:
providing an address for a mobile node;
assigning a lifetime to the provided address; and
storing the assigned lifetime.

2. A method as claimed in claim 1, comprising the step of sending a request for the provided address to at least one of an authorization server and a home agent.

3. A method as claimed in claim 1, comprising the step of sending the assigned lifetime to the mobile node.

4. A method as claimed in claim 1, wherein the step of providing the provided address for the mobile node is carried out by said mobile node.

5. A method as claimed in claim 1, wherein said providing step comprises generating a home address.

6. A method as claimed in claim 5, wherein said generating step comprises generating an interface ID.

7. A method as claimed in claim 5, wherein said generating step comprises using information relating to a home agent associated with said mobile node.

8. A method as claimed in claim 7, wherein said information comprises a home prefix.

9. A method as claimed in claim 5, wherein said generating step comprises generating an interface ID and appending said interface ID to said information.

10. A method as claimed in claim 1, comprising the step of sending the provided address to at least one of a home agent and an authorization server.

11. A method as claimed in claim 1, comprising the step of checking that the provided address is not being used by another node.

12. A method as claimed in claim 11, wherein said checking step is carried out in at least one of a home agent and an authorization server.

13. A method as claimed in claim 1 1, further comprising the step of updating a profile of said node with the provided address if said checking step confirms that said address is not being used by another mobile node.

14. A method as claimed in claim 1, comprising the step of storing the assigned lifetime in a profile of said mobile node.

15. A method as claimed in claim 1, comprising the steps of:
checking that the address is not used by another mobile node in a home agent; and
if not, checking that the address is not used by the another mobile node in an authorization server.

16. A method as claimed in claim 1, comprising the step of sending said assigned lifetime to said mobile node.

17. A method as claimed in claim 21, wherein said sending step comprises sending said lifetime to the mobile node in a binding acknowledgement message.

18. A method as claimed in claim 21, wherein said sending step comprises sending said assigned lifetime from a home agent to said mobile node.

19. A method as claimed in claim 21, comprising sending said assigned lifetime from a home agent.

20. A home agent for use in a communication system, the home agent configured to
send a message to a mobile node, wherein said message includes information relating to a lifetime of an address associated with said mobile node.

21. A communication system comprising:
providing means for providing an address for a mobile node;
assigning means for assigning a lifetime to the address; and
storing means for storing the assigned lifetime.

22. A communication system comprising:
a mobile node configured to generate an address for said mobile node; and
an authorization server for assigning a lifetime to the address and for storing the assigned lifetime.

23. An authorization server for use in a communication system, said server configured to assign a lifetime to an address provided for a mobile node and to store the assigned lifetime.

24. A mobile node for use in a communications network, said mobile node configured to generate a dynamic address and configured to receive and store information relating to a lifetime of said address.

25. A method of authorizing a static address of a mobile node, the method comprising the steps of:
sending the static address to an authorization server from a mobile node; and
authorizing said static address at said authorization server.
